(19) United States
(12) Patent Application Publication
(10) Pub. No.: US 2004/0033286 A1
(43) Pub. Date: Feb. 19, 2004

(54) Pivoting part-removal apparatus and method for inboard unloading of injection molded parts

(75) Inventors: James A. Vanderploeg, Loretto (CA); Robin A. Arnott, Alliston (CA)

Correspondence Address: HUSKY INJECTION MOLDING SYSTEMS, INC, 288 NORTH ROAD, MILTON, VT, 05468, US

(73) Assignee: Husky Injection Molding Systems LTD

(21) Appl. No.: 10/219,592

(22) Filed: Aug. 15, 2002

(51) Int. Cl. B29C 45/40

(52) U.S. Cl. 425/444; 264/334

(57) ABSTRACT

An apparatus and method for removing molded parts from a mold having cores arranged in at least two columns on a core plate. A pivoting part-removal device, preferably attached to the core plate between columns of cores, pivots parts from a column of cores to a chute located between columns of cores. The removal device has at least one pivoting arm with a part-gripping suction cup. The chute maintains an orientation of parts as they move along the chute. Parts from two columns of cores can be deposited in an interlaced arrangement into one chute. In one embodiment, the parts are translated as they are pivoted to facilitate the interlacing when the cores in adjacent columns are not staggered. In another embodiment, used when the part sidewalls are high with a low draft angle, the parts are moved straight off the cores a distance before pivoting them.

### BACKGROUND OF INVENTION

1. Field of the Invention.

The present invention relates, generally, to molding machines and is particularly, but not exclusively, applicable to the removal of injection-molded parts from multicavity molds.

2. Background Information.

Plastic parts are molded using well-known processes, such as injection molding and compression molding. In these processes, the molded parts are formed between a core and a mold cavity that together form a mold. Conventionally, the complementary core and cavity are each supported on a mold half constructed from a number of mold plates, with the molded part generally remaining on the core when the mold is opened. The state of the art includes various devices and methods for removing molded parts from multicavity molds. In many cases, after parts are removed from the core the orientation of the part is not important and the part is allowed to fall or otherwise randomly orient itself as it is transferred to a collection area. But, in many cases a particular orientation of the part needs to be maintained as it is removed from the core to facilitate subsequent processing, such as stacking, packaging or filling in the collection area. For molds that are oriented vertically, as is typical of the injection molding process, a simple removal device that maintains molded part orientation uses a pivoting arm with a suction cup that grasps each part, removes it from the core, pivots it away from the mold, and deposits it in a chute located outboard of the cores. Such a device is as disclosed in U.S. Pat. Nos. 4,589,840, 4,976,603, 5,518,387 and 5,709,833 hereby incorporated herein by reference. These patents teach using a movable device to enter an open mold space, capture an ejected molded part and transport it to a position adjacent, but external to, the mold so that the part can be released and dropped down a vertical chute. The chute is typically mounted on the outboard edge or side of one of the mold halves so that when the mold is closed for the next molding cycle a complementary part of the chute is formed by an attachment on the opposed mold half. The molded part is typically held by a suction cup mounted to an arm that is mounted to a rotatable shaft and driven between a loading position and unloading position by either mechanical or electrical drive means. The molded parts are deposited in the vertically oriented chute which maintains their orientation as the parts drop down the chute to the collection area. Other removal devices, such as a robot arm, can also be used in combination with the vertical chutes to accomplish the same task.

Prior art devices are believed to have significant limitations and shortcomings. Specifically, since the molded parts must be removed to an outboard position of the mold for deposit in the chutes mounted thereon, these devices are applicable to multicavity molds that have no more than two columns of cores mounted to a single mold face. In any event, the part removal operation is time consuming and therefore diminishes the efficiency of the molding cycle. There is no teaching of applying these devices to mold core layouts having more than two columns of cores. There is a need for a part-removal device that is operational with respect to molds having higher cavitations in layouts of more than two columns of cores to increase the efficiency of the part removal operation when orientation of the molded parts is to be maintained during removal.

### SUMMARY OF INVENTION

The present invention provides an apparatus and method for removing molded parts from a mold in a plastic molding machine. The apparatus is a mold plate assembly comprising a core plate adapted to support, in use, a plurality of cores configured in at least two columns of cores. The core plate has at least one part-removal device coupled to the core plate and operative between a first position at which the part-removal device, in use, selectively engages a molded part formed on a core on the plate, and a second position inboard of the core at which the molded part is released. The core plate is further adapted to receive, in use, a chute portion couplable to the core plate at the second position, such that the chute portion, in use, receives molded parts provided by the removal device in a predetermined orientation.

Preferably the mold plate assembly includes at least one chute portion attached to the core plate and located between the columns of cores, the chute portion, in use, receiving molded parts from the part-removal device. The assembly also preferably has an opposing mold plate opposite the core plate, the opposing mold plate having a complementary chute portion attached to it which cooperates with the chute portion attached to the core plate when the core plate and mold plate come together so as to form a chute having a profile that maintains the orientation of the parts as they move along the chute.

The part-removal device preferably comprises a plurality of swing arms pivotally connected to the core plate by a rotatable shaft. Each swing arm has an end that preferably has at least one suction cup which grasps the part.

Preferably, each chute has a pair of the pivoting part-removal devices associated with it and disposed between two columns of cores. Each removal device services one of the columns of cores such that parts from both columns of cores are deposited into the chute in an interlaced arrangement.

In one embodiment, the shaft is moved axially as it rotates, preferably by means of a drum cam attached to the shaft, thereby translating the at least one swing arm as it pivots. This is used to facilitate interlacing of the parts from both columns of cores at the chute when the cores in adjacent columns are not staggered.

In another embodiment, used when the parts have a low sidewall draft angle, the parts are moved straight off the cores a distance before pivoting them. The apparatus to do this preferably includes a mechanism that moves the shaft laterally away from the core plate when the swing arms are at the first position before the shaft begins to rotate.

The invention also provides a method of removing molded parts from cores arranged in at least two columns on a core plate in a plastic molding machine. The method comprises the steps of grasping the molded parts on the cores with a removal device, moving the parts to a chute located between two adjacent columns of cores, and releasing the parts in the chute so that the parts move along the chute in a manner that maintains an orientation of the part in the chute.

The present invention provides a part-removal apparatus and method which overcomes the limitations and shortcomings of the prior art. Advantageously, the present invention increases molding efficiency by reducing cycle time.

### BRIEF DESCRIPTION OF DRAWINGS

FIG. 1 is a plan view of a prior art core-plate portion of a mold with chutes outboard of the core columns.

FIG. 2 is a plan view of a core-plate portion of a mold with staggered core columns, the mold incorporating a molded part-removal system according to a preferred embodiment of the present invention.

FIG. 3 is an isometric view of a core-plate portion of a mold with staggered core columns incorporating a molded part-removal system according to a preferred embodiment of the present invention.

FIG. 4 is an isometric view of another core plate portion of a mold with aligned core columns incorporating a molded part-removal system according to a preferred embodiment of the present invention.

FIG. 5 is a plan view of a portion of the embodiment shown in FIG. 4 showing the swing arms in the loading position.

FIG. 6 is the view of FIG. 5 showing the swing arms in the unloading position and showing an alternative drive for the part-removal device.

FIG. 7 is a partial mold layout of the embodiment shown in FIG. 3 showing an alternate drive means for the swing arms (shown in the unloading position).

FIG. 8 is a section view taken along line 8-8 of FIG. 5 of a mold incorporating a molded part-removal system according to a preferred embodiment of the present invention showing the swing arms in the loading position.

FIG. 9 is the view of FIG. 8 showing the swing arms in the unloading position with the mold open.

FIG. 10 is the view of FIG. 9 showing the swing arms in the release position with the mold closed for the next molding cycle.

FIG. 11 is the view of FIG. 8 of another embodiment of the invention showing an alternate swing arm mounting system in which the swing arms are in the loading position.

FIG. 12 is the view of FIG. 11 showing the swing arms in the retracted position.

FIG. 13 is the view of FIG. 12 showing the swing arms in the unloading position.

FIG. 14 is the view of FIG. 13 showing the swing arms in the release position and with the mold closed for the next molding cycle.

### DETAILED DESCRIPTION

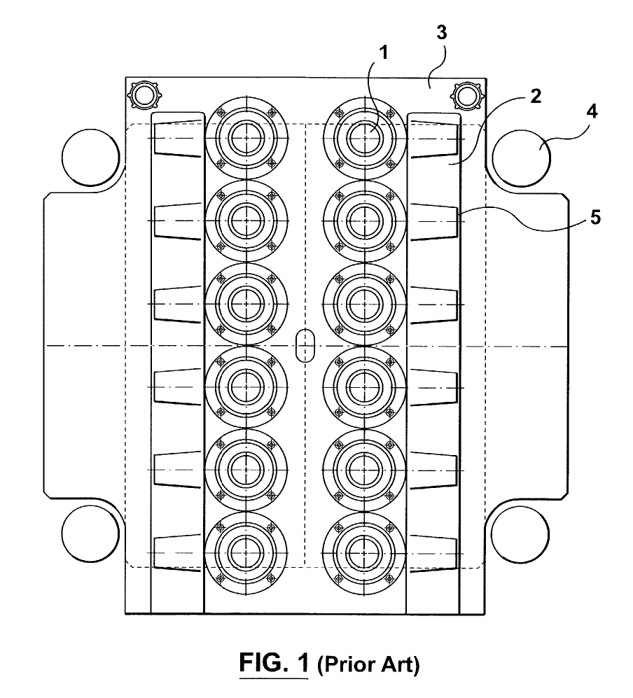

Referring to FIG. 1, which illustrates the prior art, a core-plate portion of a mold is shown in which the cores 1 are arranged in two columns and pivoting removal devices (not shown), typically referred to as swing arms, deposit the molded parts 5 in chutes 2 that are mounted on the plate 3 outboard of the cores 1 and within the spacing of the tiebars 4. The swing arms pivot through an angle of about 90 degrees to transfer the parts from the mold cores 1 to the chutes 2. Because the swing arm rotation is only 90 degrees, the width of the discharge chutes 2 is determined by the height of the parts 5. Thus, for very deep parts, a very wide chute is necessary, for which there may not be enough space on the mold between the cores and the tie bars.

The present invention provides for chutes and removal devices to be mounted between columns of cores and inboard of the outer columns of cores, thereby facilitating the use of swing arms and chutes for molds with any number of columns of cores.

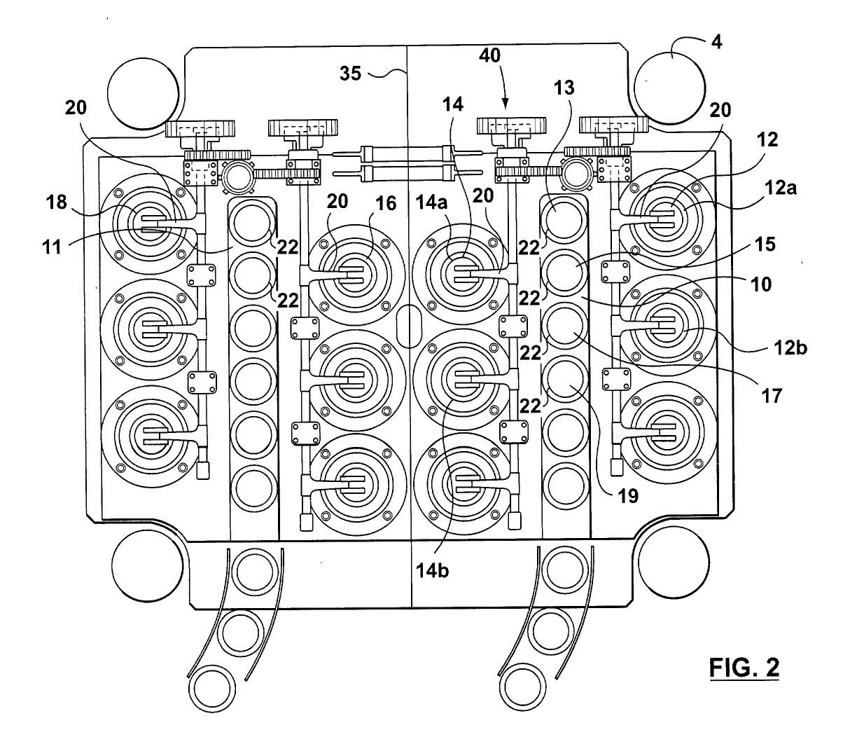

Referring to FIG. 2, illustrating a preferred embodiment of the invention, four columns of mold cores 12, 14, 16, and 18 are shown spaced on a core plate to include a drop chute portion 10 positioned between adjacent columns 12 and 14, and a drop chute portion 11 positioned between adjacent columns 16 and 18. Chute portions 10 and 11 and their associated removal devices are all attached to the core plate and located inboard of the outer columns 12 and 18. In this embodiment, the cores on opposite sides of a drop chute portion are staggered horizontally so that the parts removed from the cores on either side of a drop chute portion can be positioned alternatingly in the chute portion. Thus the part from core 12a is released at position 13, the part from core 14a is released at position 15, the part from core 12b is released at position 17, the part from core 14b is released at position 19, and so on. This allows parts from two columns of cores to be moved simultaneously to a single chute, with the parts interlacing in the chute. Preferably, cores are mirrored about the core plate centerline 35 to better balance the hot runner for the mold.

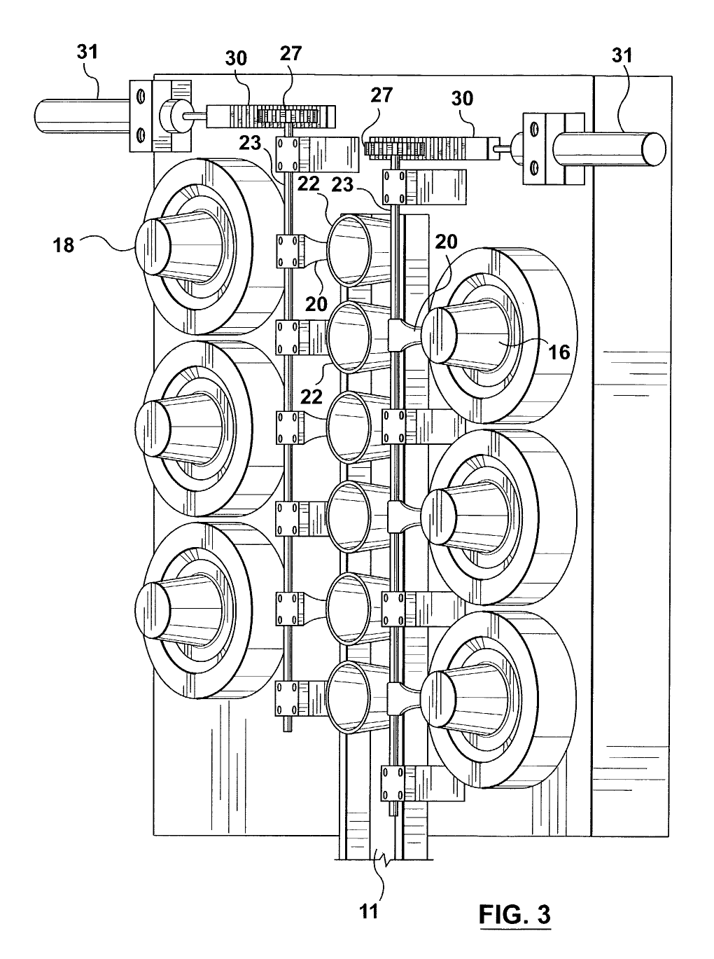

Referring also to FIG. 3, to remove the parts 22 from the cores and position them for release in a drop chute portion 11, the swing arms 20 pivot approximately 180 degrees between a first position at which the part is engaged and grasped and a second position at which the part is released in the chute portion 11. Because the swing arm rotation is approximately 180 degrees, the width of the drop chute portion 10 or 11 is only slightly larger than the width of the part, thereby minimizing the space required within the mold area to accommodate the chute portions 10 and 11; this contrasts with the prior art systems in which the width of the chute must reflect the greatest depth of a molded part formed in the mold. Each swing arm 20 is attached to a shaft 23 located adjacent and generally parallel to its associated chute. Each shaft 23 is driven by a reversible drive apparatus, such as a rack and pinion gear arrangement or its functional equivalent. Gear 27 is attached to an end of shaft 23, and is driven by rack 30 which is moved by actuator 31. In this embodiment, the shafts 23 and their drive apparatus are staggered similar to the core columns 16 and 18. The shafts 23 and their attached swing arms 20 simply rotate to cause the swing arms 20 to pivot between the first position and the second position and thereby interlace the parts from both columns of cores as they are placed in the chute portion 11.

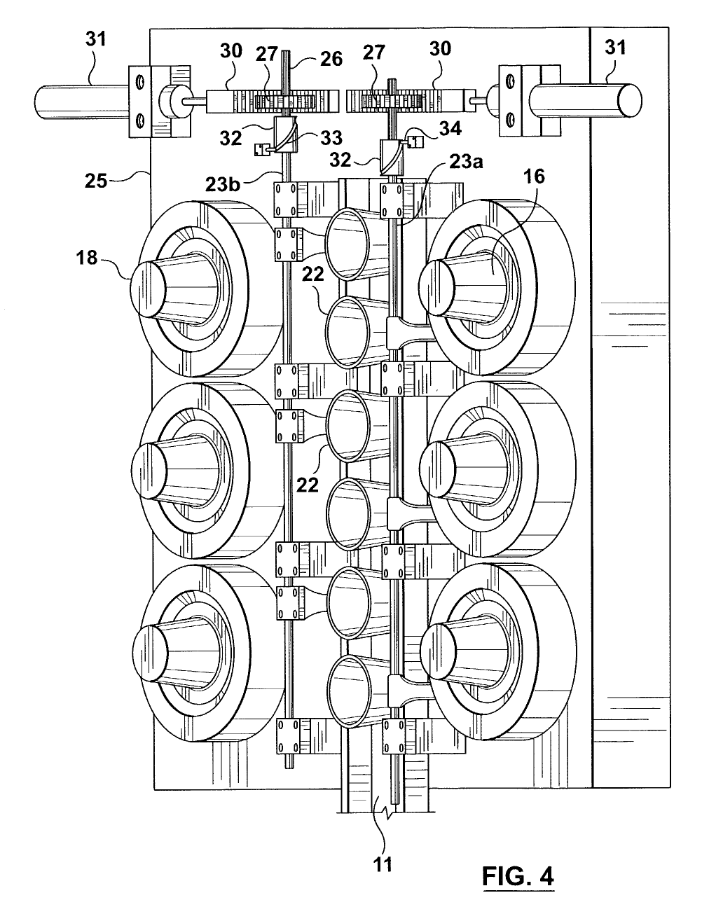

Referring to FIG. 4, the invention can be used on a mold with conventional core layout. Here the cores are not staggered horizontally, but are arranged in a rectilinear grid layout, which simplifies the hot runner for the mold. The swing arms 20 are shown in the release position with the parts arranged in the drop chute portion 11. In this embodiment the shafts 23 on which the swing arms are mounted are arranged to move axially in addition to rotating so that the parts are not only pivoted inboard from their core positions but also are translated vertically to facilitate their interlacing in the drop chute portion 11.

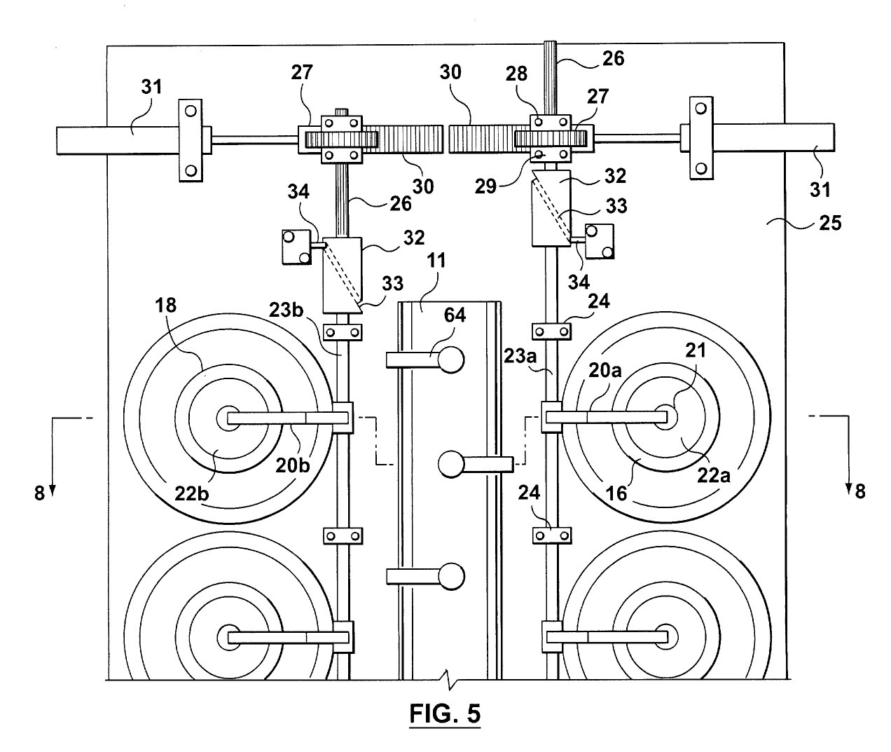

Referring also to FIG. 5, which shows the embodiment of FIG. 4, but with the swing arms 20 in the loading position, each arm 20 carries at least one suction cup 21 that selectively grips and releases a molded part 22. Suction cup 21 is connected to a vacuum source (not shown) for positively engaging and grasping the part 22. When the vacuum source is disconnected, the suction cup releases the part. As each arm 20 pivots, the at least one suction cup 21 removes a part 22 from a core. Though an arm with only one suction cup has been shown, a plurality of suction cups may be used, as necessary, depending on the size of the molded part to be removed.

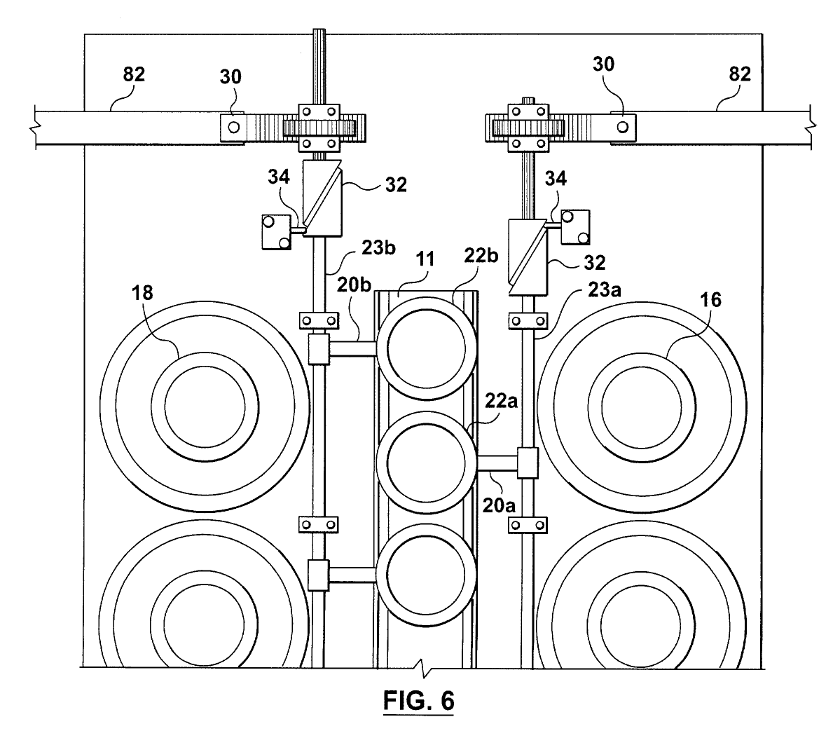

The arm 20 is fastened to a shaft 23 that is both rotatably and axially mounted in bearing posts 24 that are mounted on the core plate 25. The end of the shaft 23 has a splined portion 26 and carries a gear 27 that is housed between two bearing posts 28 and 29, such that the gear 27 is free to rotate but is held in position vertically by the bearing posts so that the splined portion 26 of shaft 23 can slide vertically through the gear 27 while being rotated by the gear 27 when it is turned. A rack 30 has teeth that engage and drive the teeth of the gear 27. The rack is driven by actuator 31, preferably a pneumatic or hydraulic cylinder, in conventional fashion so that in operation the actuator 31 causes the shaft 23 to rotate sufficiently to move the swing arm 20 from its loading position to its unloading position and beyond to its release position. Alternately the rack can be driven by a linkage 82 (shown in FIG. 6) and a cam operated by the motion of the mold and/or movable platen of the molding machine in known fashion.

A drum cam 32 having a cam profile 33 therein is mounted on each shaft 23 such that a cam follower 34, fixed to the plate 25, causes the shaft 23 to move vertically as the drum cam 32 is rotated by the shaft 23. By arranging the cam profile 33 correctly, each shaft 23 can be made to raise or lower in synchronization to a particular direction of rotation of the shaft 23. As illustrated on the right half of FIG. 5, the shaft 23a will lower as swing arm 20a moves from its loading position to the unloading position, shown in FIG. 6. All other swing arms mounted to the same shaft move similarly. Similarly, as shown on the left side of FIG. 5, the shaft 23b is raised as it is rotated by its corresponding gear, rack and actuator arrangement when arm 20b moves from its loading position to its unloading position. Consequently, as shown in FIG. 6, the part 22a is positioned below the part 22b when both are moved into the drop chute portion 11. This alternate positioning, or interlacing, of parts in the drop chute portions optimizes the space requirements of the mold design. Obviously, reversing the operation of the actuators 31 restores the swing arms to their loading positions when required.

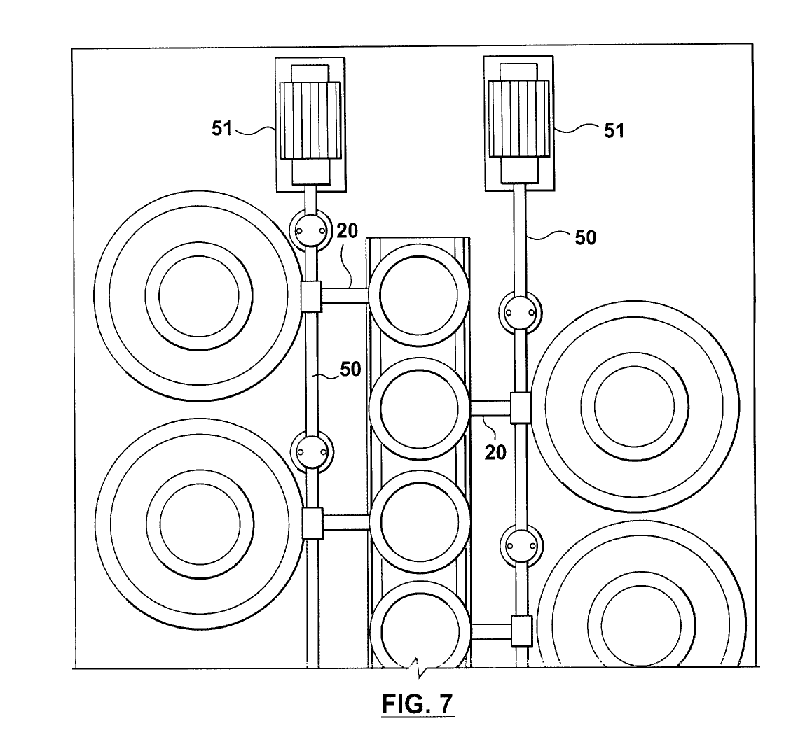

Referring to FIG. 7, an alternate reversible drive apparatus is applied to the shafts 50 when the present invention is used with a mold having a horizontally staggered core layout. In this configuration each shaft 50 is not required to move vertically, thereby simplifying the drive apparatus. In this embodiment, each shaft 50 is rotated by an electric servo motor 51 that is controlled in a known manner to move the swing arms 20 from their loading positions to their unloading and release positions and back again for a repeatable molding cycle. It would also be possible to use a similar electric servo motor (or the like) with the rectilinear mold core layout of FIGS. 5 and 6 by using a splined coupling shaft in place of the gear, rack and cylinder arrangement shown in those figures.

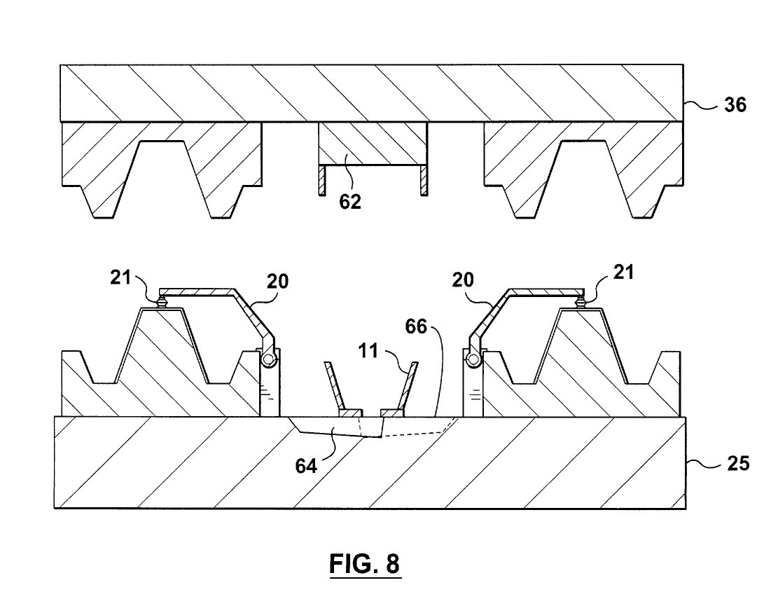

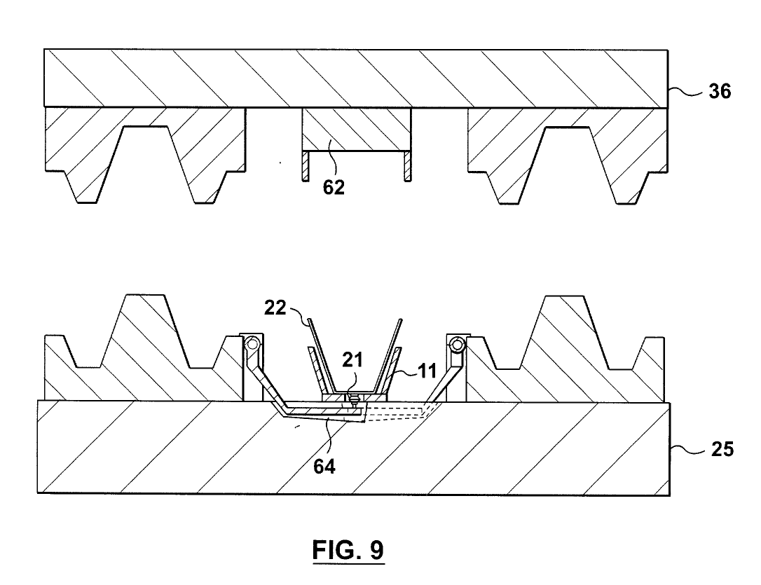

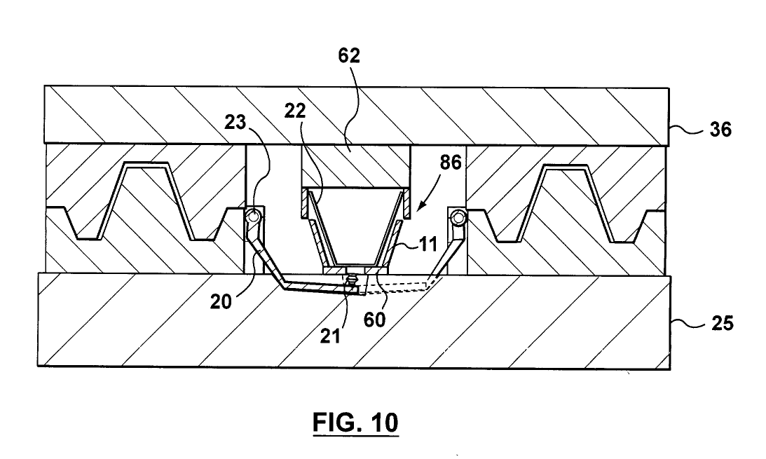

Referring to FIGS. 8-70, illustrating section views of the embodiment shown in FIG. 5, FIG. 8 shows the mold-open position with the swing arms 20 in the loading position. FIG. 9 shows the swing arms 20 in their unloading position, the swing arms having been pivoted approximately 180 degrees from the loading position. FIG. 10 shows the swing arms 20 in their release positions, where the vacuum source has been disconnected so that the suction cups 21 release the parts 22 in the drop chute portion 11 and the swing arms 20 have been rotated slightly further to retract the suction cups 21 from the drop chute floor to allow a clear path for the falling molded parts. A complimentary drop chute portion 62, attached to the opposing mold plate 36, cooperates with drop chute portion 11 to form a closed drop chute 86 with a profile that ensures that the parts 22 fall freely and do not misalign or jam in the chute 86. The chute 86 is constructed and arranged to maintain the orientation of parts 22 deposited therein as the parts 22 move along the chute. Cutouts 64 in the core plate 25 and corresponding cutouts (not shown) in drop chute portion 11 provide clearance for the swing arms 20 and suction cups 21 to drop below the surface 66 of core plate 25 in the unloading positions.

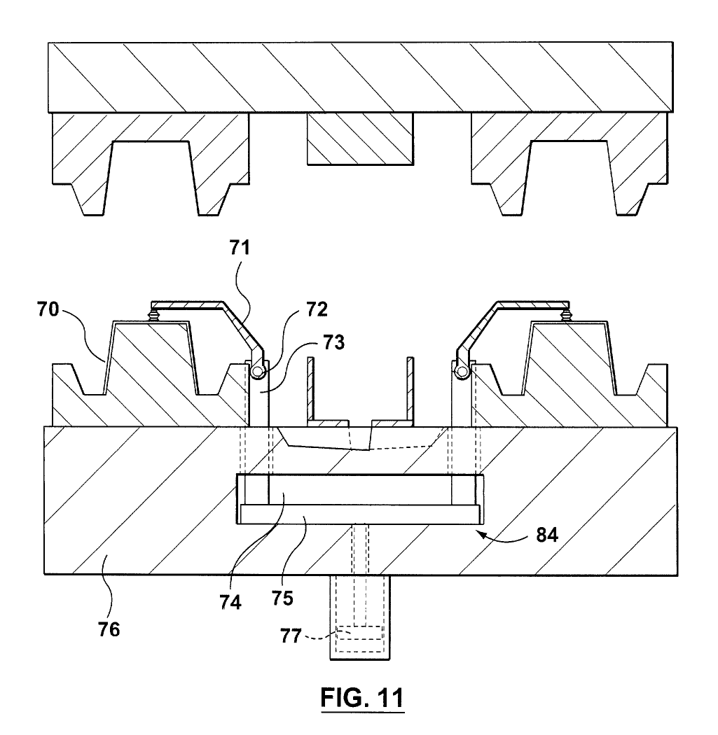

Referring to FIGS. 11-14, another embodiment of the invention is shown for handling of molded parts 70 with a steep sidewall. In cases where the sidewall draft angle is small and the height of the part is large such that the combination of the two prevents the swing arm from removing the part from the core without jamming, the parts can be first moved straight off the cores a distance before pivoting them. This is preferably accomplished by moving the entire swing arm 71 and shaft 72 away from the core plate 76 prior to the swing arm commencing its rotary motion. The distance moved depends on the draft angle and height of the part 70. FIG. 11 shows the swing arm 71, shaft 72 and bearing post 73 assemblies mounted on a translation mechanism 84, such as a movable plate 75 housed in a cavity 74 in the core plate 76. The plate 75 is reciprocatingly moved by drive device 77, which is preferably an air cylinder, or hydraulic cylinder, but may be any other functionally equivalent drive device, including an electric servo motor.

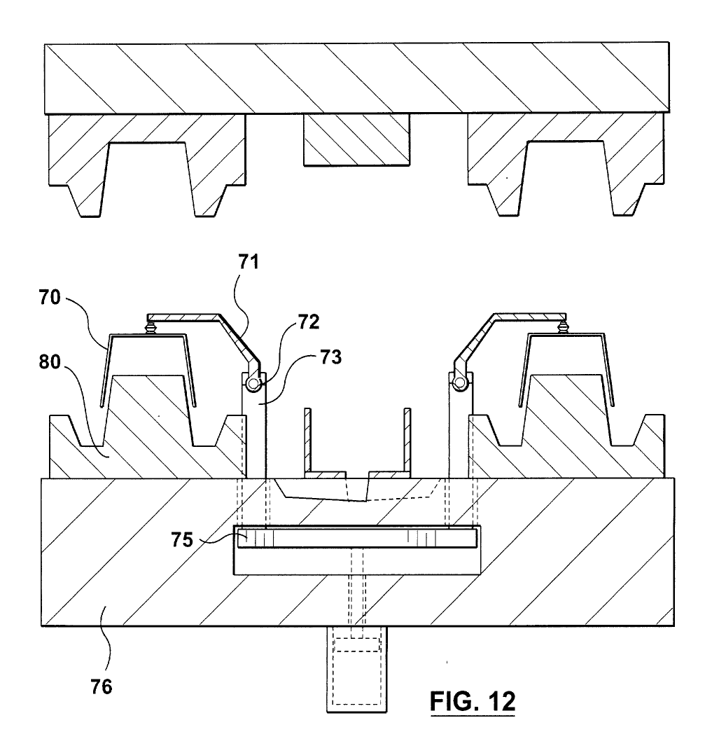

FIG. 12 shows the plate 75 advanced to move the bearing post 73, shaft 72 and swing arm 71 assembly away from the core plate 76, thereby increasing the clearance between the molded part 70 and the core 80. This motion can occur before or simultaneously with the rotation of the swing arm 71 and can be arranged by timing the motion of plate 75 to allow the earliest removal of the part 70 from the core 80 without jamming.

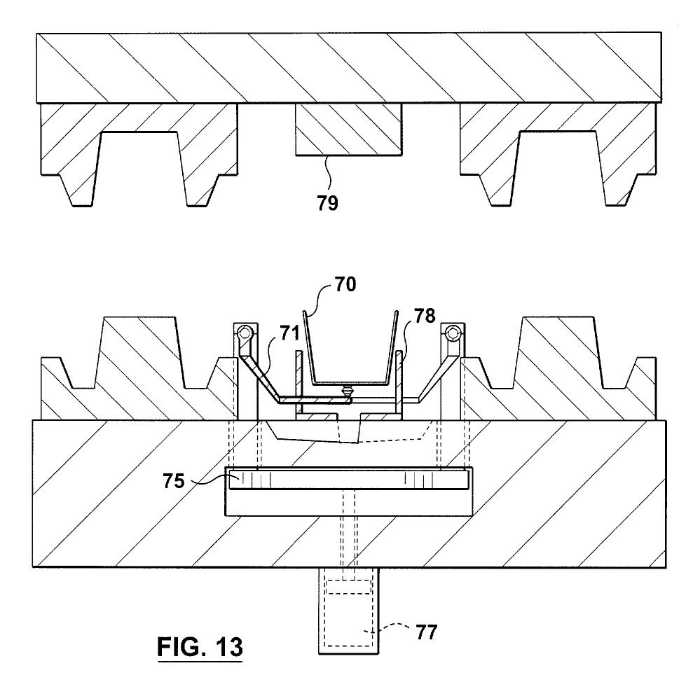

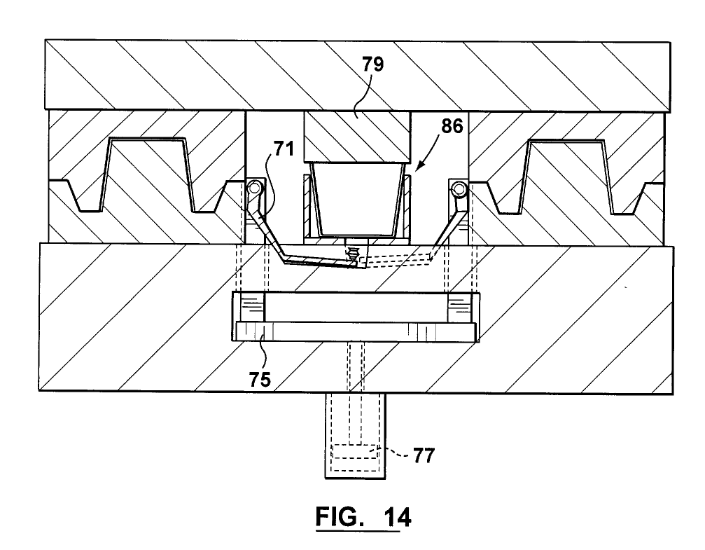

FIG. 13 shows the swing arm 71 having completed its rotation and having aligned the part 70 above the drop chute portion 78. After swing arm 71 completes, or nears completion of its rotation, the plate 75 is returned to its retracted position by drive means 77 as shown in FIG. 14. The mold is closed, ready for the next molding cycle, and the complementary drop chute portion 79 attached to the opposing mold plate is brought into position adjacent drop chute portion 78 to complete the drop chute 86. The vacuum means is shut off and the swing arm 71 is moved to its release position allowing the parts to drop down the chute 86, as previously described.

The invention as described above has at least one chute and swing arm mounted between columns of cores on a mold, thereby facilitating the use of swing arms and chutes for molds with any number of columns of cores.

It will, of course, be understood that the above description has been given by way of example only and that modifications in detail may be made within the scope of the present invention. For example, while a preferred embodiment of the invention has been illustrated with regard to a mold having two or four columns of cores, it can be applied to molds having more columns of cores by repeating the structure for each pair of columns of cores. An advantage of using the present invention with a mold having only two columns of cores is that it allows a single chute to be used to collect the molded parts.

1. A mold plate assembly comprising:
a core plate adapted to support, in use, a plurality of cores configured in at least two columns of cores;
at least one part-removal device coupled to the core plate and operative between a first position at which the part-removal device, in use, selectively engages a molded part formed on a core on the core plate, and a second position inboard of the core at which the molded part is released; and
wherein the core plate is further adapted to receive, in use, a chute portion couplable to the core plate at the second position, such that the chute portion, in use, receives molded parts provided by the removal device in a predetermined orientation.

2. The assembly of claim 1, further comprising at least one chute portion attached to the core plate and located between the columns of cores, the at least one chute portion, in use, receiving molded parts from the part-removal device.

3. The assembly of claim 2, further comprising an opposing mold plate opposite the core plate, the opposing mold plate having a complementary chute portion attached to it which cooperates with the chute portion attached to the core plate when the core plate and mold plate come together so as to form a chute having a profile that maintains the orientation of the parts as they move along the chute.

4. The assembly of claim 1, wherein the removal device comprises a plurality of swing arms pivotally connected to the core plate.

5. The assembly of claim 4, wherein each swing arm has an end with at least one suction cup that selectively grasps and releases the part.

6. The assembly of claim 4, wherein each swing arm is attached to a rotatable shaft connected to the core plate and located adjacent and generally parallel to one of the columns of cores, the shaft facilitating pivoting motion of the swing arms attached thereto.

7. The assembly of claim 6, wherein the swing arms pivot approximately 180 degrees between the first position and the second position.

8. The assembly of claim 6, wherein the shaft is rotated by a reversible drive apparatus.

9. The assembly of claim 8, wherein the reversible drive apparatus includes one of:
a rack and pinion gear connected to the shaft;
a servo motor connected to the shaft; and
a linkage and cam operated by the motion of the molding machine.

10. The assembly of claim 8, wherein the shaft is moved axially as it rotates thereby translating the swing arms attached thereto as it pivots.

11. The assembly of claim 10, wherein the shaft has a drum cam attached that causes the shaft to move axially as it rotates.

12. The assembly of claim 6, wherein the core plate has an upper surface from which, in use, the plurality of cores extend, and a portion of the removal device is positioned below the upper surface of the core plate in the second position.

13. The assembly of claim 12, wherein the shaft is attached to a translation mechanism that moves the shaft laterally away from the core plate when the swing arms are at the first position before the shaft begins to rotate.

14. The assembly of claim 13, wherein the translation mechanism is a plate disposed in a cavity in the core plate, the plate being reciprocatingly moved in the cavity by a drive device connected to the plate.

15. An assembly for removing molded parts from a mold in a plastic molding machine, the mold having a plurality of cores arranged in at least two columns on a core plate, the assembly comprising:
at least one chute attached to the mold and located between columns of cores, the chute being constructed and arranged to maintain an orientation of parts deposited therein as the parts move along the chute; and
a removal device that positively engages and grasps a molded part, removes it from the core, and deposits it in the at least one chute.

16. An assembly for removing molded parts from a mold in a plastic molding machine, the mold having a plurality of cores arranged in at least two columns on a core plate, the assembly comprising:
at least one chute portion and an associated pivoting part-removal device attached to the core plate, each chute portion and associated part-removal device being disposed between a pair of columns of cores, the pivoting part-removal device including a rotatable shaft with at least one swing arm attached to the shaft, each swing arm having an end with at least one suction cup that positively engages and grasps a molded part on a core, the shaft being driven to move the at least one swing arm between a first position at which the part is engaged and grasped on the core and a second position at which the part is released in the chute portion.

17. The assembly of claim 16, wherein each chute portion has a pair of the pivoting part-removal devices associated with it, each removal device servicing one of the columns of cores such that parts from two columns of cores are deposited into the chute portion in an interlaced arrangement.

18. The assembly of claim 17, further comprising an opposing mold plate opposite the core plate, the opposing mold plate having a complementary chute portion attached to it which cooperates with the chute portion attached to the core plate when the core plate and mold plate come together so as to form a chute having a profile that maintains the orientation of the parts as they move along the chute.

19. A method of removing molded parts from cores arranged in at least two columns on a core plate in a plastic molding machine, the method comprising the steps of:
grasping the molded parts on the cores with a removal device;
moving the parts to a chute located between two adjacent columns of cores; and
releasing the parts in the chute so that the parts move along the chute in a manner that maintains an orientation of the part in the chute.

20. The method of claim 19, wherein the step of moving the parts is accomplished by pivoting the parts from the cores to the chute.

21. The method of claim 20, wherein parts from two adjacent columns of cores are deposited in an interlaced arrangement in the chute.

22. The method of claim 21, wherein the parts from one column of cores are moved laterally relative to the parts from another column of cores as the parts are pivoted to facilitate interlacing of the parts from both columns of cores at the chute.

23. The method of claim 20, wherein the step of moving the parts includes the sub step of moving the parts straight off the cores a distance before pivoting them.
